(19) United States
(12) Patent Application Publication
(10) Pub. No.: US 2006/0260491 A1
(43) Pub. Date: Nov. 23, 2006

(54) INK PROOFER DRIVE SYSTEM

(76) Inventor: Ronald K. Westby, Ramsey, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/382,619

(22) Filed: May 10, 2006

Related U.S. Application Data
(60) Provisional application No. 60/679,481, filed on May 10, 2005.
(60) Provisional application No. 60/679,484, filed on May 10, 2005.
(60) Provisional application No. 60/679,367, filed on May 10, 2005.
(60) Provisional application No. 60/679,483, filed on May 10, 2005.
(60) Provisional application No. 60/679,576, filed on May 10, 2005.

(51) Int. Cl. B41F 1/34

(52) U.S. Cl. 101/480

(57) ABSTRACT

A kit for use in preparing ink proofs including an ink proofing tool having an anilox roller shiftable between a first position in contact with an impression roller and a second position not in contact with the impression roller, an ink proofer apparatus including an endless movable transport surface and a holder to support the ink proofing tool, the holder being shiftable between a first position wherein the impression roller is not in contact with the transport surface and a second position wherein the impression roller is in contact with a substrate supported by the transport surface; and at least two endless movable transport surfaces which have different preselected surface qualities and which are exchangeably couplable to the ink proofer apparatus.

### CLAIM TO PRIORITY

This application claims priority to United States Provisional Applications 60/679,481, filed May 10, 2005, entitled “Ink Proofer Driver System,” 60/679,484 filed May 10, 2005, entitled “Ink Proofer With Reservoir,” 60/679,367 filed May 10, 2005, entitled “Multi Ink Proofer Arrangement With Computer Management System,” 60/679,483 filed May 10, 2005, entitled “Multi Ink Proofer Arrangement,” and 60/679,576 filed May 10, 2005, entitled “Ink Proofer Arrangement Photo Calibration,” the contents of all of which are incorporate herein by reference.

### TECHNICAL FIELD

The present invention relates generally to the fields of flexographic, gravure and offset printing and, more particularly, to a portable flexographic ink proofing apparatus for providing proofs of ink samples for purposes of color and density correction and press correlation to mimic printing properties.

### BACKGROUND OF THE INVENTION

In the field of flexographic printing ink samples are obtained by drawing ink over a substrate using a hand ink proofer, for example, of the type manufactured by Harper Companies International of Charlotte, N.C. The ink is applied to the substrate by manually rolling the hand proofer across the substrate. Manual ink proofer tools are utilized for proofing ink colors in order to accurately predict the results to be obtained by running a selected ink specimen in a printing press. A computer microscope is then used to view the ink smear on the substrate. The computer then indicates to the technician various color components to be added to the ink in order to achieve the desired ink coloration.

In a flexographic printing operation, rubber plates are utilized for delivering the ink to the stock or paper to be printed. A flexographic ink technician is usually given an ink specimen which has been determined to be acceptable for use on a particular press, and a production run sample, to be used as the standard for color and density. One of the most difficult tasks facing a flexographic ink technician is proofing an ink in a manner so that the color will duplicate the color of the production run sample from the flexographic printing press. It is well known among those skilled in the art that if three trained technicians pull an ink proof, using the same ink on the same hand proofer tool, three different color shades will result.

The shade of a color on a flexographic printing press is dependent on the thickness of the ink film applied to the substrate or stock. The ink film thickness is determined by the speed of the press, the pressure applied between the printing plate and paper (i.e., impression), and the pressure between the rollers on the printing unit. Similarly, the shade of a color on a flexographic hand proofer tool is also dependent on the thickness of the ink film applied to the substrate which is determined by the speed at which the technician pulls the hand proofer tool across the substrate, and the impression pressure the technician applies to the hand proofer tool while moving it across the substrate. Thus, the speed and impression is totally dependent on the manual skill of the flexographic ink technician, while the only variable not controlled by the technician is the pressure between the ink roller and transfer roller of the manual proofer tool.

U.S. Pat. No. 6,814,001 describes an ink proofer designed to overcome the problems associated with conventional manual proofer tools by generating consistent and reliable ink draws using a hand-held proofer tool retained in a movable mounting assembly. A variable pressure system is coupled to the mounting assembly to move the proofer tool into a contact position with a cylindrical drum. The transfer roller of the proofer tool then transfers ink to a substrate inserted between the drum and the transfer roller of the proofer tool when a drive motor for the drum is engaged.

Ink proofs may be drawn on various substrates such as paper, plastics, fabric and like materials. Substrates vary in their frictional qualities. Thus, it would be desirable to vary the proofing arrangement to compensate for the frictional qualities of the substrates.

### SUMMARY OF THE INVENTION

The ink proofer of the present invention substantially meets the aforementioned needs of the industry. According to one aspect of the present invention, a digital speed control and an adjustable print pressure mechanism are provided such that the speed, impression and roller pressure are completely controlled by the ink proof technician, whereby the same ink color will be duplicated each time the apparatus is used. Thus, the technician can compensate for variations in the resiliency of the impression roll as well as the drive roller of the proofing apparatus.

According to one aspect of the invention, the ink proofer apparatus provides for the constant speed roller which feeds paper through the device at a constant speed to generate a uniform ink smear. Further, the ink proofer apparatus provides for regulated pressure between the roller and an underlying drum on which the roller bears. Pressure can be regulated to compensate for differing resiliency of the impression roll and the drive roller. Additionally, in one example embodiment, the ink proofer apparatus is explosion proof being an all pneumatic device.

According to another aspect of the present invention, the ink proofer apparatus includes a rotating drum that is disposed opposite and beneath a proofer roll of a hand ink proofer tool. The proofer roll of the proofer tool is elevated above the rotating drum and is lowered into compressive rotatable engagement with the rotating drum when the substrate (preferably paper) is introduced between the drum and the roller. The substrate advances between the roller and the drum at a selected speed. The pressure of the roller acting on the drum is selectable by an operator. Prior to the substrate paying out, a sensor senses the imminent end of the substrate and raises the roller to prevent contamination between the roller and the drum by contact between the roller and the drum when no substrate is present.

In one example embodiment, an ink proofer apparatus is adapted to be used with an ink proofer tool, the ink proofer tool including an ink transfer roller. The ink proofer apparatus further includes a cylindrical roller and a drive motor adapted to rotate the roller. In addition, a first movable mounting assembly is included that retains the ink proofer tool adjacent to and in a non-contact position with the roller. The proofer apparatus further includes a first variable pressure assembly coupled to the mounting assembly and adapted to move the ink proofer tool into a contact with pressure position with the roller and further adapted to move the ink proofer tool into the non-contact position, wherein the transfer roller is adapted to transfer ink to a substrate that is inserted between the roller and the transfer roll of the ink proofer tool when the drive motor is engaged.

In another related embodiment, an ink proofer apparatus is adapted to be used with an ink proofer tool, the ink proofer tool including an ink transfer roller, a cylindrical roller and a drive motor adapted to rotate the roller. In addition, a mounting assembly adapted to retain the ink proofer tool adjacent to and in a non-contact position with the roller. The ink proofer apparatus also includes a movable support assembly adapted to support the roller and a first variable pressure assembly coupled to the movable support assembly and adapted to move the roller into a contact with pressure position with the ink proofer and to move the roller into a non-contact position with the ink proofer tool, wherein the ink transfer roller is adapted to transfer ink to a substrate that is inserted between the roller and the transfer roll of the ink proofer tool when the drive motor is engaged.

The above summary of the present invention is not intended to describe each illustrated embodiment or every implementation of the present invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an embodiment of an ink proofer apparatus of the present invention;

FIG. 2A is a top view of an ink proofer tool that is mountable on one embodiment of the ink proofer apparatus of the present invention.

FIG. 2B is a side view of an ink proofer tool of FIG. 2A.

FIG. 3 is a top view of the ink proofer apparatus with certain components depicted in phantom.

FIG. 4 is a side elevational view of the ink proofer with certain components depicted in phantom.

FIG. 5 is an end elevational view of the ink proofer.

FIG. 6A is a universal ink proofer holder in accordance with the present invention with a schematically represented ink proofer mounted therein.

FIG. 6B is one embodiment of the universal proofer holder of FIG. 6A in accordance with the present invention.

FIG. 6C is a side view of the universal proofer holder illustrated in FIG. 6B.

FIG. 7 is a perspective view of one embodiment of the cover plate for the universal proofer holder.

FIG. 8A is a front schematic view of another embodiment of an ink proofer apparatus of the present invention.

FIG. 8B is the top schematic view of the ink proofer apparatus illustrated in FIG. 8A.

FIG. 8C is a side view of the ink proofer apparatus illustrated in FIG. 8A.

FIG. 9 is an elevational view of a substrate roll attachment for the ink proofer apparatus of the present invention.

FIG. 10 is a schematic drawing of actuation of the pressure cylinder controlling the universal proofer holder in accordance with the present invention.

FIG. 10A is another schematic drawing of actuation of the pressure cylinder controlling the universal proofer holder in accordance with the present invention

FIG. 11 is a perspective view of another embodiment of an ink proofer apparatus of the present invention.

FIG. 12 is an elevational side view of the ink proofer apparatus illustrated in FIG. 11.

FIG. 13 is a side view of a universal proofer holder with a detachable ink proofer cartridge in accordance with the present invention mounted thereon.

FIG. 14 is a side elevational view of another embodiment of the ink proofer with a take-up roll apparatus partially depicted in phantom.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

The present invention is generally directed to an ink proofer apparatus that is adapted to operate with a variety of hand ink proofer devices to provide ink proofs that are reliable and repeatable and that are consistent from one ink proof to another. While the present invention is not necessarily limited to such an application, the invention will be better appreciated using a discussion of example embodiments in such a specific context.

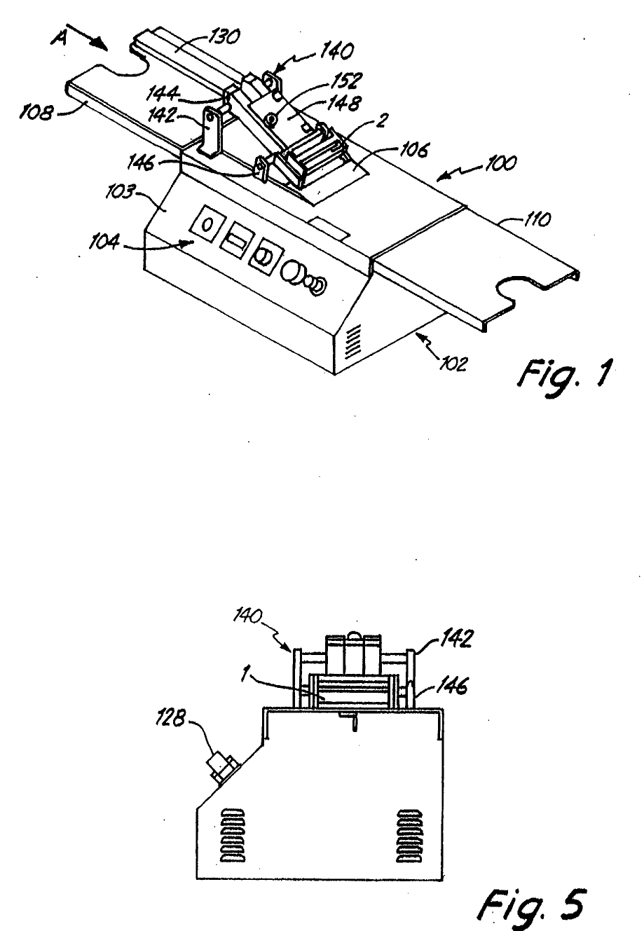

Referring now to the Figures, FIG. 1 illustrates a perspective view of an embodiment of an ink proofer apparatus 100 of the present invention. In this example embodiment, referring to FIGS. 1 and 3-5, ink proofer apparatus 100 includes base unit 102 that supports hand ink proofer tool 1 and is configured to move a substrate (not shown) through the unit via a base roller 106 to produce an ink proof Base unit 102 includes control panel 104 and pair of support plates 110 and 108 (optional, depending on the length of the substrate) that can be simply clipped on when desired. In another embodiment, support plates 110 and 108 include a pair of guide rails (not shown) for guiding a sheet of paper or other substrate through base unit 102. The combination of base unit 102 and ink proofer tool 1, according to the teachings of the present invention, facilitate generating ink proof samples irrespective of the manual ink drawing skills of the operator. Further, proofer apparatus 100 of the present invention is advantageously not necessarily limited to ink proofer tools of the type described hereinafter.

Proofer apparatus 100 further includes housing 103, which in this example embodiment, is made to be spill proof such that the proofer apparatus can be washed down easily without damaging any of the internal components. Mounted on housing 103 are a number of control switches and displays that comprise control panel 104. Protruding from the upper surface of housing 103 is rubber roller 106 that is driven by a drive motor (for moving a substrate in the direction of arrow A). Roller 106 is an example of a movable endless surface that can be used to transport a substrate. Roller 106 can be replaced by, for example, a conveyor belt or other movable endless surface to transport the substrate. Proofer apparatus 100 is also configurable to have roller 106 rotate in the opposite direction so that the arrangement is bidirectional with respect to movement of the substrate. Base unit 102 further includes support plates 108, 110 which can be mounted optionally on base unit 102 when the substrate is of considerable length.

In one embodiment the invention includes a kit including at least two rollers 106 or other movable endless surfaces which are interchangeably couplable to proofer apparatus 100. The two rollers 106 or other movable endless surfaces each may have different surfaces having different preselected surface qualities. The surface qualities may include variations in resiliency. For example, rollers 106 may include metallic drums whose surface has been treated in various ways. The surface treatment may be selected from a group consisting of polishing, chroming, anodizing, nickel plating and hard coating. This group should not be considered limiting. The surface qualities may include a resilient elastomeric coating having a durometer hardness of, for example, between about forty and about seventy five.

Manual ink proofer tool 1 is supported on base unit 102 via an ink proofer tool support arrangement 140. In its simplest form proofer tool support arrangement 140 is simply an angled support structure that is affixed to the top of base unit 102 for supporting ink proofer tool 1 at a predetermined angle. In this particular embodiment, tool support arrangement 140 is movable in a substantially vertical direction so as to raise and lower ink proofer tool 1 up and away from roller 106 or down and into contact with roller 106. Tool support arrangement 140 may include a vertical fixed support bracket 142 that is coupled to a proofer tool support plate 144 that is in turn coupled to a proofer tool movement mechanism 146 which moves generally up and down through the surface of the base unit 102 thereby moving ink proofer tool 1 as desired. Ink proofer tool 1 is secured to support arrangement 120 via proofer tool secure plate 148 and secure plate 152.

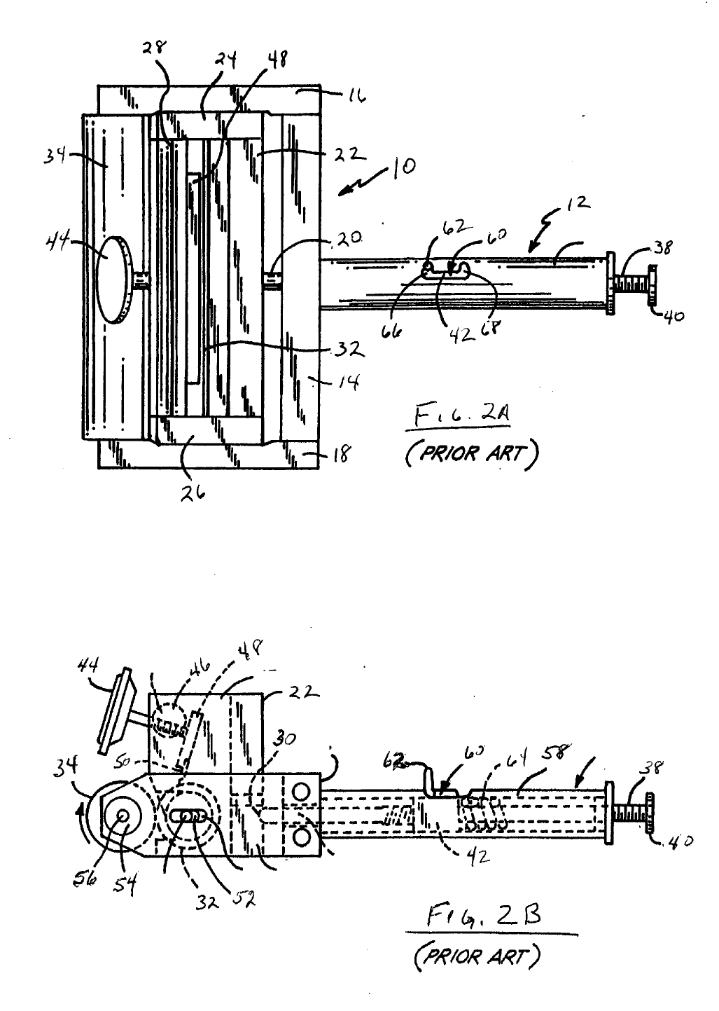

FIGS. 2A and 2B illustrate top and side views, respectively, of an exemplary ink proofer tool 1 that is mountable on one embodiment of the ink proofer apparatus 100. As depicted in FIGS. 2A and 2B, an exemplary prior art hand proofing tool 10 includes handle 12, base frame 14 and sideframes 16 and 18. Base frame 14 has a hole that accommodates pressure rod 20 along with a threading for attaching handle 12 to base frame 14. Sideframes 16 and 18 extend outwardly from base frame 14. Connected to sideframes 16 and 18 of base frame 14 is anilox roll-nesting subframe 22. Subframe 22 has sides 24 and 26, as well as a blade adjustment means holder 28. Additionally, subframe sides 24 and 26 may be grooved and sideframes 16 and 18 may be likewise grooved in a complementary fashion so that they fit into one another. Indentation 30 receives pressure rod 20 and helps maintain proper alignment of the subframe 22 within sideframes 16 and 18.

Anilox roll 32 is located within nesting subframe 22 such that anilox roll pin 34 extends from anilox roll 32 at least partially into or through elongated orifices 36, on each of sideframes 16 and 18. Anilox roll 32 is pressed against transfer roll 34 and pressure rod 20 maintains the pressure against nesting subframe 22 so that it forces anilox roll 32 against transfer roll 34 at a predetermined pressure resulting from rotation of pressure rod adjustment means 38, by rotating gripping dial 40, for example, clockwise to tighten and counterclockwise to loosen. Pressure rod adjuster 38 is threaded and fits into pressure rod release means collar 42. Collar 42 is held in a position so that as pressure rod adjustment means 38 is rotated it causes the subframe 22 and anilox roll 32 to move accordingly.

Connected to subframe blade adjustment means holder 28 is blade adjustment means 44, in this case, a rotatable dial which includes screw 46 which passes through holder 28. At the end of screw 46 is blade holder 48 and doctor blade 50 set up as a follower-type doctor blade 50 so that ink may be located behind the doctor blade 50 and the doctor blade 50 will both act as a wiping blade and as a distributing fountain. By rotation of blade adjustment means 44, for example clockwise to go upwardly away from subframe 22 and counterclockwise to go downwardly, doctor blade 50 may be adjusted against the surface of anilox roll 32 accordingly.

In prior art hand proofing tool 10, the anilox roll 32 has bearings 52 to facilitate ease of rolling. Bearings 52 are adapted to fit over the anilox roll pins 43 and are contained within a washer-type fitting which nests within the subframe 22. Sideframes 16 and 18 each also include transfer roll pin holding insert 54 adapted to receive transfer roll pins 56, as shown.

Handle 12 and hollow member 58, include pressure rod release means 60 which includes a cut-out as shown, pressure rod release means collar 42 and pressure rod release means lever 62, as well as spring 64. Spring 64 is located to push collar 42 and therefore pressure rod adjustment means 38 and pressure rod 20 against subframe 22. When pressure rod release means lever 62 is located in first position 66, pressure rod 20 is engaged with subframe 22 and, therefore, under pressure. The pressure rod release means lever 62 may be pushed clockwise then away from the subframe 22 and then counterclockwise (in other words, in a “U” shaped path), to move from first position 66 to second position 68. In second position 68, pressure rod 20 is totally disengaged from subframe 22 and subframe 22 may be easily removed or rotated for cleaning of anilox roll 32 without altering the setting and therefore the pressure relationship which will be re-achieved when pressure rod release means lever 62 is moved from second position 66 back to first position 68.

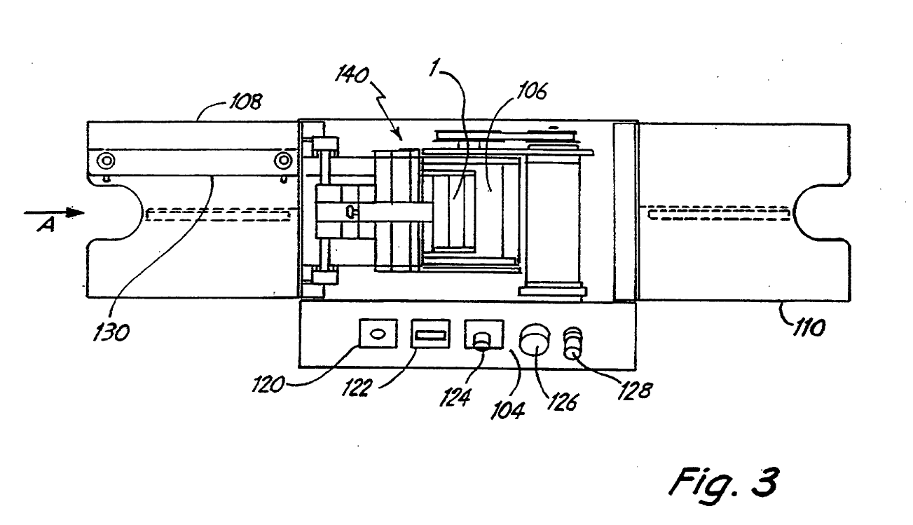

Referring to FIGS. 3-5, an embodiment of proofer apparatus 100 of the present invention is shown. Base unit 102 includes main housing 103 in which drive roller 106 is mounted. Drive roller 106 is driven by drive motor (not shown) within base unit 102.

Drive roller 106 includes a cylindrical metallic drum, which may be constructed from a variety of materials, for example steel, stainless steel, aluminum, titanium, or other comparable suitable materials. Drive roller 106 may also be subject to a surface treatment, for example polishing, chroming, anodizing, nickel plating, or hard coating. These listings of materials should not be considered limiting.

In one example embodiment, drive roller 106 may be formed of steel, having a chromed surface finish. The use of drive rollers of differing materials may provide various benefits to an ink proofer technician, or to the ink proofer apparatus itself. Different materials exhibit unique properties, such as hardness or resiliency, and it may be desirable to vary the material of the drive roller 106 or other movable endless surface according to the requirements of the sample being prepared. Further, certain materials may present advantages such as increased durability, reduced wear, light weight, or low cost.

In an alternative embodiment, drive roller 106 comprises a cylindrical metallic drum having an elastomeric covering. Drive roller 106 may support elastomeric coverings with varying hardness (according to a Durometer measurement). Based on variables present in the ink proofer apparatus such as substrate composition, pressure of the ink proofer tool 10, and drive roller 106 speed, an ink proofer technician may find it advantageous to use drive rollers 106 or other movable endless surfaces of differing hardness, in order to achieve a desired ink film thickness, color or appearance. An ink proofer technician can interchange drive rollers 106, allowing the simulation of various conditions when preparing an ink sample. The application of ink onto certain substrates may require the use of a drive roller 106 having a greater or lesser resiliency than is commonly used.

Further, drive rollers 106 of greater or lesser resiliency may be advantageous due to variations in the pressure and/or speed the ink proofer apparatus 100 is operated at, which may affect the application of the ink onto a substrate, the thickness of the ink film, or the appearance of the ink upon the substrate. Drive rollers 106 with elastomer coatings having a Durometer hardness in the range of about 40 to about 70 may be appropriate.

In addition, the impression roll or transfer roll of a proofing tool may also be formed of materials of differing resiliency.

As illustrated in FIG. 3, control panel 104 includes, in this example embodiment, on/off switch 120 which can be substituted with a push button so as to control the proofer manually as the substrate is fed through the proofer apparatus 100. Control panel 104 also includes digital speed display 122 as well as speed control button 124 for setting the speed from anywhere to 200-900 FPM or 400-1500 FPM (feet per minute). Pressure gauge 126 is also included which provides feedback to the user when using air regulator 128 to control the pressure of the roller 106 against the rollers of the ink proofer tool 10. Base unit 102 further includes substrate guide 130 for insuring that the substrate is fed evenly through proofer apparatus 1 00.

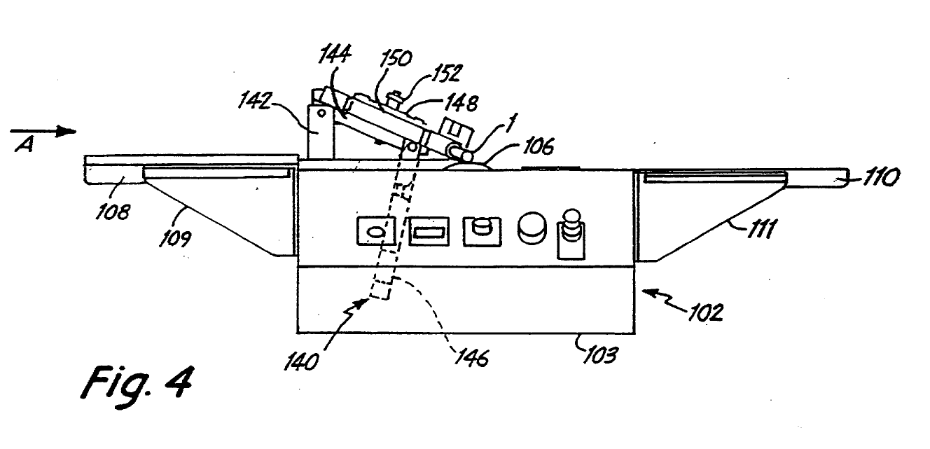

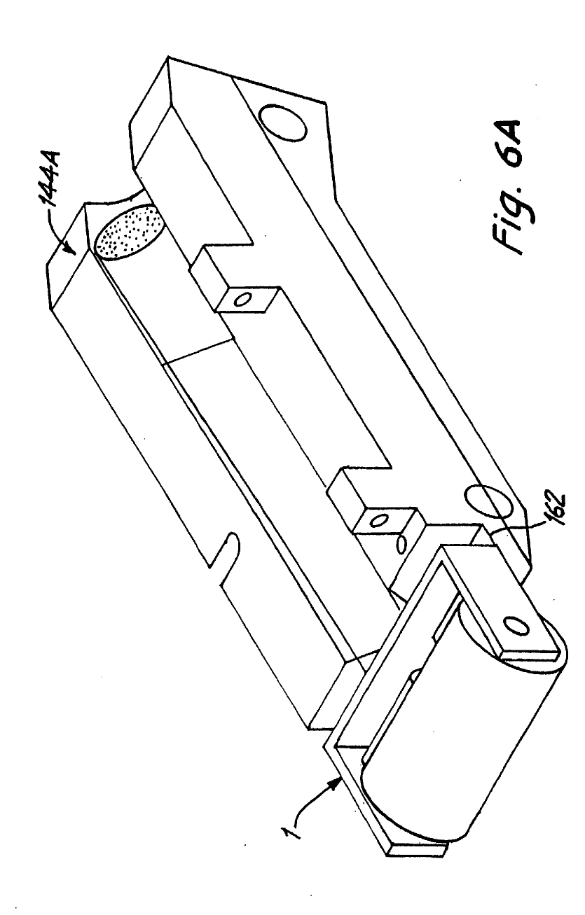

Referring to FIG. 4, in this example embodiment, proofer apparatus 100 is configured to lift ink proofer tool 1 above roller 106 to provide the additional feature of keeping the roller 106 clean until the substrate is fed through apparatus 100 and proofer tool 1 is then placed on the substrate. In this example embodiment, proofer tool mechanism 146 senses that the substrate is about to terminate so as to push up the proofer tool 1, thereby preventing ink from flowing onto roller 106. In a related embodiment, where a proofer tool movement mechanism 146 is not included, the operator can manually stop proofer apparatus 100 before the substrate comes to the end.

Referring to FIG. 5, there is illustrated a side view of proofer apparatus 100 with the ink proofer tool 1 resting on the surface of roller 106. Ink proofer tool 1 is also resting on ink proofer tool support arrangement 140 located over base unit 102.

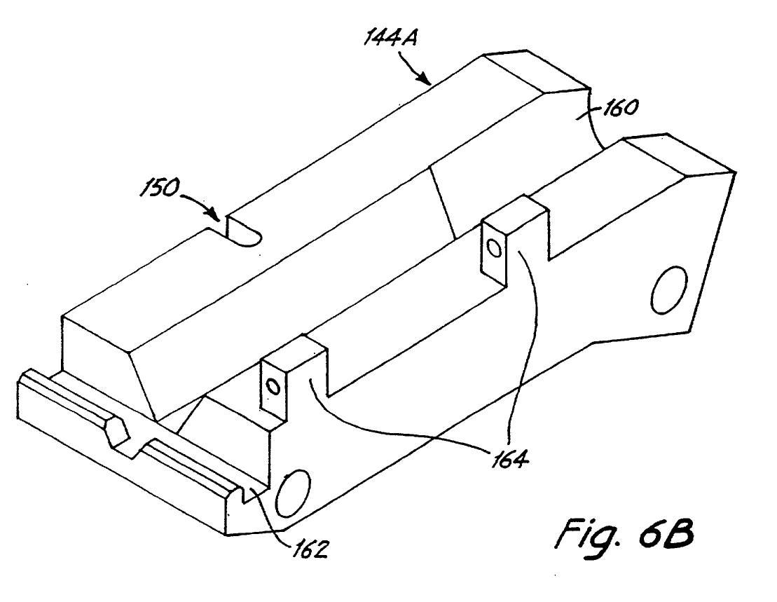

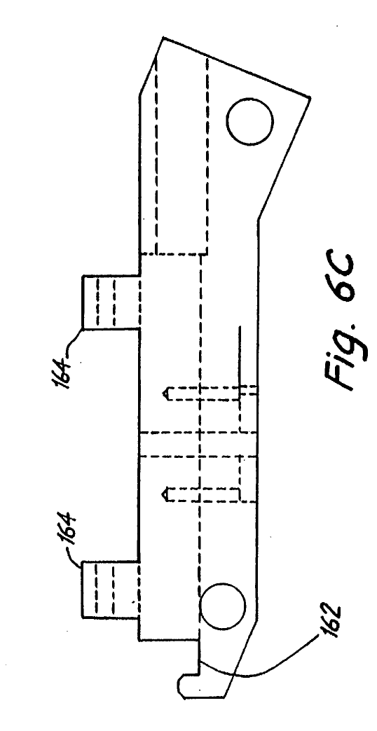

Referring now to FIG. 6A, there is illustrated ink proofer tool 1 that is set within universal proofer holder 144a according to the present invention. The ink proofer is held within holder 144a via notch 162.

FIG. 6B illustrates universal proofer holder 144A without ink proofer tool 1. Universal proofer holder 144A includes channel 160, which accommodates the handle of the ink proofer 1, and notch 162 that aids in maintaining the proofer in universal proofer holder 144a. Universal holder 144a further includes a set of hinges 164 that engage a cover plate that maintains the ink proofer tool 1 in the universal holder. Holder 144A further includes aperture 150 for accommodating fastening screw 152 that maintains the cover plate over universal holder 144A.

FIG. 6C illustrates a side view of universal holder 144A which includes notch 162 and hinges 164. In this embodiment, universal holder 144A may be made from a polymer (i.e., plastic) but can also be made from metal or any other material that can be formed to include a channel 160 and notch 162. Channel 160, in this example embodiment, is formed in a V-shaped groove; however, it can be formed in a square groove or circular groove depending on the proofer handle configuration.

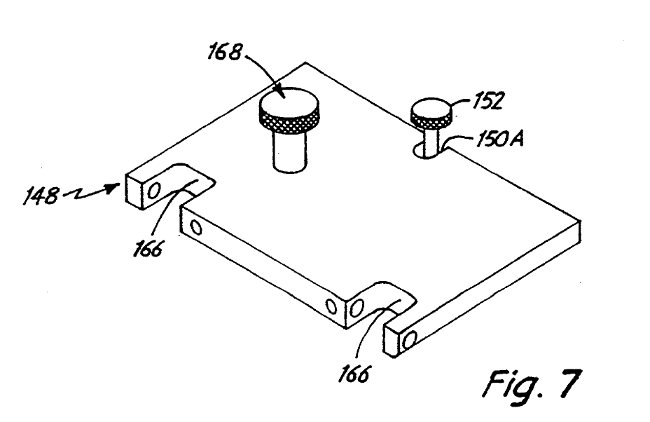

FIG. 7 illustrates one example embodiment of cover plate 148 that includes hinge apertures 166 that engage hinges 164 of universal holder 144A. Cover plate 148 further includes aperture 150A that aligns with 150 on universal holder 144a for accommodating fastening screw 152. This example embodiment of cover plate 148 further includes an adjustment knob 168 for adding downward pressure to an ink proofer handle located in channel 160 to secure the proofer holder in channel 160. Adjustment knob 168 provides the advantage of allowing universal holder 144a to accommodate the proofer handles of various diameters while still allowing some angular movement in the proofer handle during the ink draw down process.

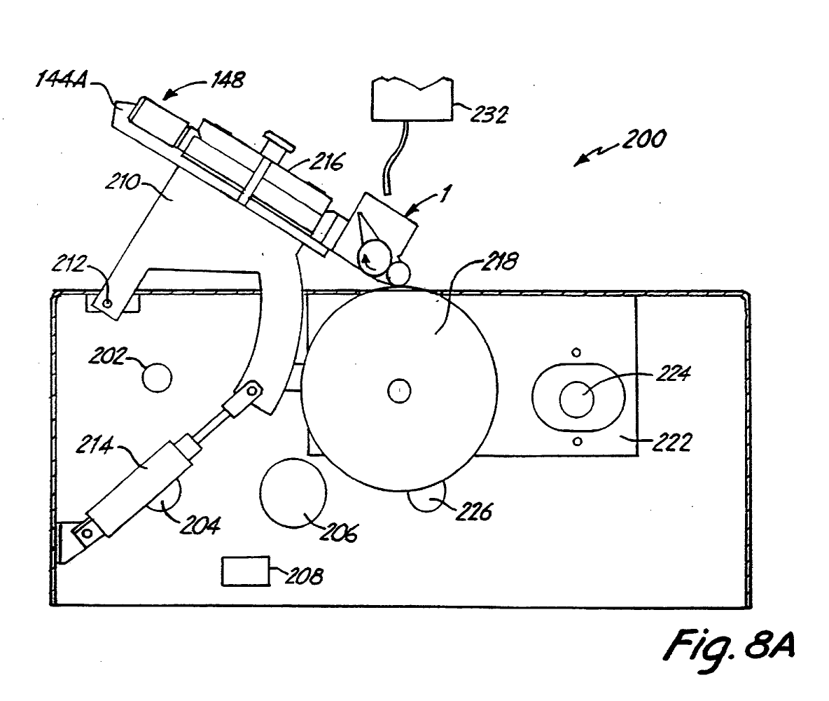

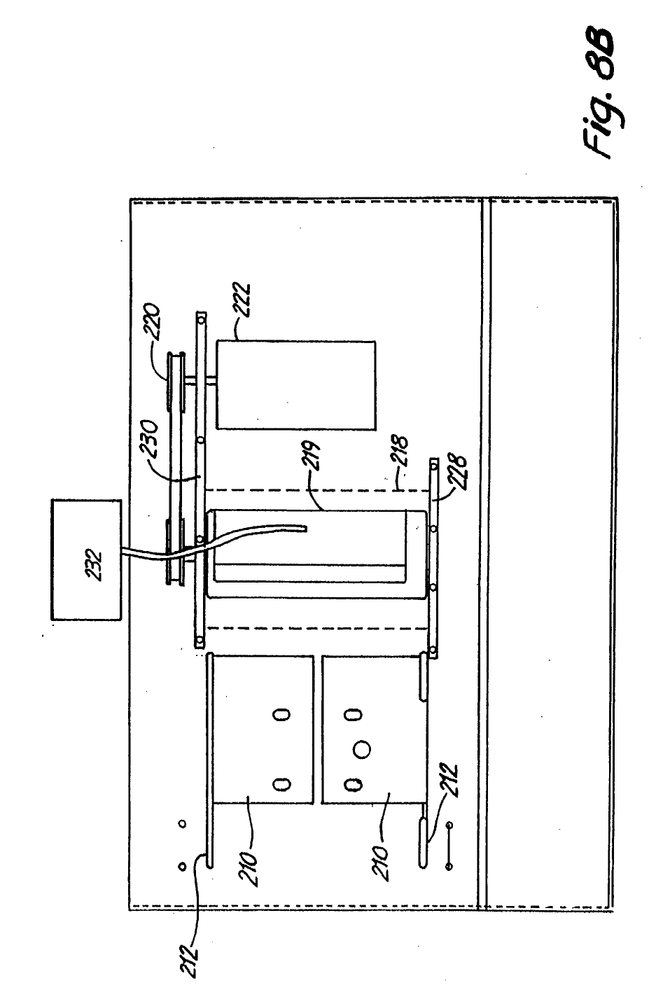

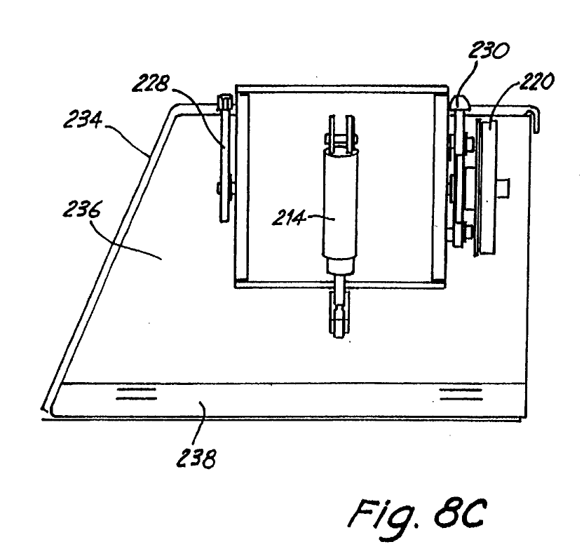

Referring now to FIGS. 8A-8C, there is illustrated another example embodiment of proofer apparatus 200 that is configured to automatically lift ink proofer tool 1 (default position) above roller 218 when start button 266 is disengaged. Proofer apparatus 200 includes pressure gauge 202 and pressure adjust 204 which allows the user to adjust the pressure of hand proofer tool 1 on the substrate used to create the ink proof. Proofer apparatus 200 further includes speed adjust 206 and digital speed read-out tool 208 that allows the user to adjust the speed of drive roller 106 that moves the substrate under the ink proofer tool 1. Unibody frame 210 that accommodates universal holder 144A and ink proofer tool 1 is attached to pivot point 212 of apparatus 200. The other end of unibody frame 210 is attached to actuation/pressure cylinder 214, which operates to move unibody frame generally vertically, thereby moving the proofer handle up when proofer apparatus 200 is actuated by start button 226. Proofer apparatus 200 further includes proofer tool support assembly including universal holder 144A, cover plate 148 and hand proofer tool 1. Roller 218 is driven by belt and pulley drive 220 (desirably via a cogged belt) that is further driven by air motor 222 located adjacent the coated drive roller 106. The speed of motor 222 is controlled by air motor speed control 224 via the exhaust of motor 222.

FIG. 8B illustrates a top view of proofer apparatus 200 that includes unibody 210 that pivots around pivot points 212. Roller 218 protrudes through roller window 219, which defined by top plate of proofer apparatus 200. Roller 218 is supported by roller support bracket 228 and roller and motor support bracket 230. Motor 222 drives pulley drive 220 which in turn drives roller 218 thereby moving the substrate across the surface of proofer apparatus 200. In this example embodiment, an ink well 232 with a tube can be adapted to provide a continuous supply of ink to the proofer tool disposed above the substrate and roller 218.

FIG. 8C illustrates a side view of proofer apparatus 200 including pulley drive 220 and brackets 228 and 230. In addition, housing of proofer apparatus 200 includes a spill proof top 234 with spill proof sides and back 236 as well as an open vent bottom 238. With open vent bottom 238 proofer apparatus 100 and 200 can be easily washed down and cleaned because fluids can drain through open vent bottom 238 and proofer apparatus 200 can air dry quickly to facilitate its use in industrial environments.

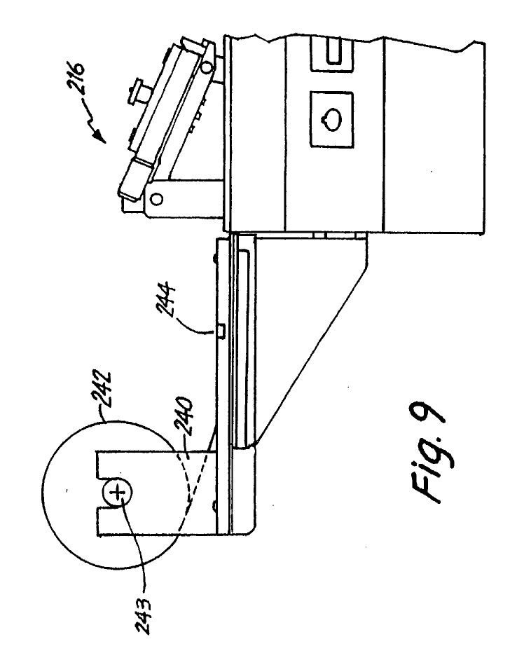

FIG. 9 illustrates substrate roll support 240 that can be attached to any of proofer apparatus disclosed herein. Substrate roll support 240 includes at least one bracket for mounting substrate roll 242 via rod 243 that helps to roll the substrate past a cutting groove 244 and under proofer tool support assembly 216. This embodiment allows the user with ink proof samples of various sizes depending on the desired application. Substrate can also be configured with or to include perforations in order to simplify preparation of ink proofs without having to provide a paper or substrate cutter to the proofer apparatus.

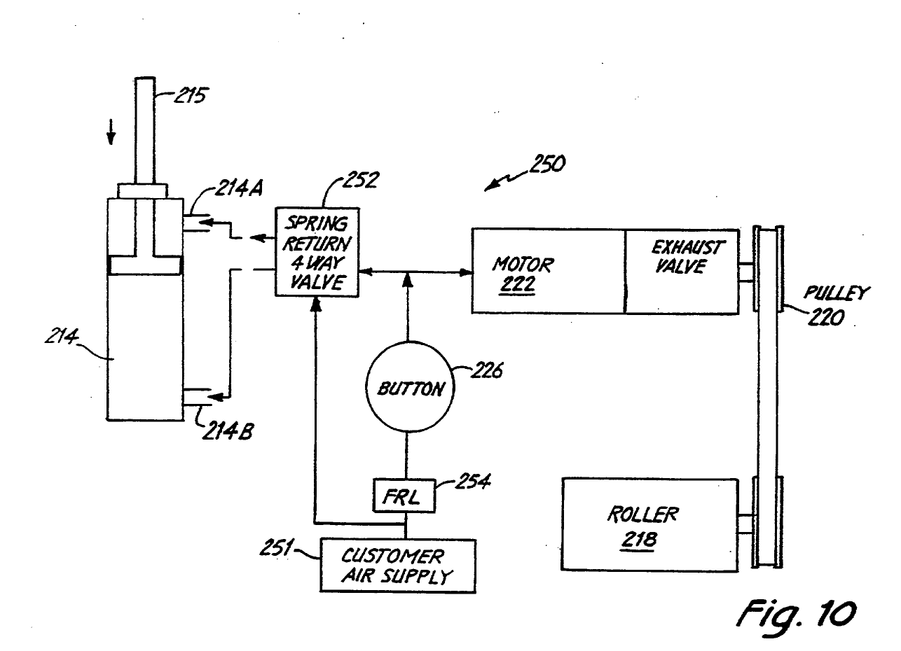

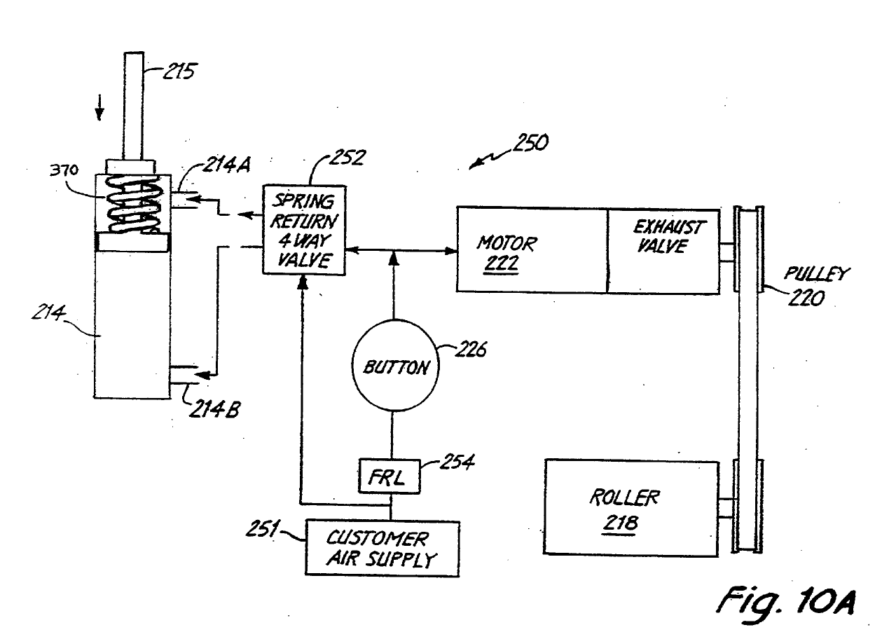

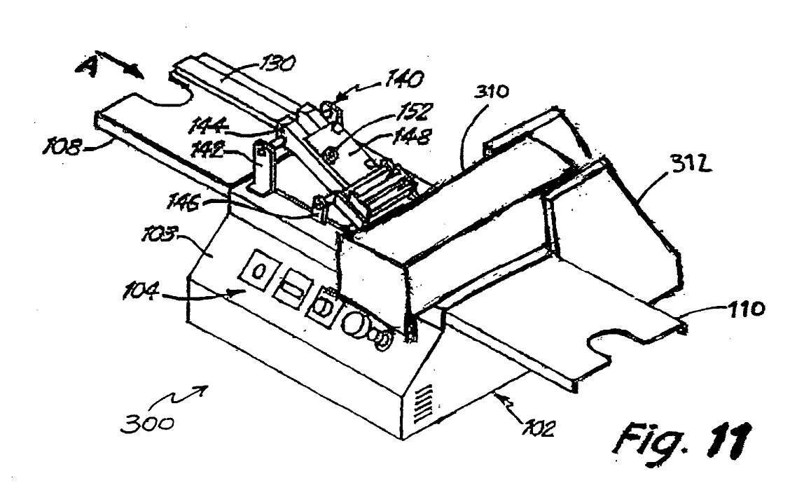

FIG. 10 illustrates a schematic of hand proofer pressure actuation system 250 according to the teachings of the present invention. In particular, system 250 assists in moving proofer tool support assembly 216 generally vertically with respect to roller 218. System 250 receives air from the customer's plant via air supply 251 which is thereafter provided to spring return four-way valve 252 and to regulator lubricator device 254 before it is connected to start button 226. When start button 226 is actuated air is provided to both motor 222 and to valve 252. Motor 222 in turn drives pulley drive 220 which drives roller 218. The air supplied by pressing button 226 in turn actuates valve 252 such that air is supplied to either upper port 214A of pressure cylinder 214 or lower port 214B which raises or lowers piston 215 within cylinder 214. Moving piston 215 within pressure cylinder 214 in turn moves unibody 210 generally vertically with respect to roller 218. When button 226 is released, cylinder 214 returns to its default position, which is the up position away from roller 218. System 250 is configured such that when button 226 is actuated roller 218 begins to rotate as unibody 210 drops down to engage the substrate and roller 218. Once button 226 is released roller 218 stops rolling because the air supply to motor 222 has been cut off and piston 215 of cylinder 214 returns to its extended position thereby raising the unibody frame 210.

In an alternative embodiment, system 250 can be configured to add a pressure cylinder to roller 218 such that the roller 218 is moved generally vertically into window 219 when button 226 is depressed and moves away from window 219 when button 226 is released. In yet another embodiment, system 250 is configurable to include two pressure cylinders such that both unibody 210 with ink proofer 1 moves in a downward direction towards roller 218 while roller 218 moves in an upward direction so as to engage the substrate at the surface of the proofer apparatus. With appropriate controls the pressure of ink proofer 1 can be adjusted online depending on the types of proofs that are desired. For instance, as the proof is being developed different pressures can be applied along the length of the ink proof to determine which pressure setting is most appropriate for placing the ink on the substrate. One of the advantages of the present invention is that pressure of the ink proofer can be varied from ink proofer apparatus 200 and need not be controlled from ink proofer tool 1. In addition, the speed can also be controlled from proofer apparatus 200 as pressure is simultaneously varied without interfering with ink proofer tool 1.

In another embodiment, proofer apparatus 100 and 200 can include end of substrate sensors to disengage the hand proofer tool and prevent ink from flowing over roller 218 and onto the top of proofer apparatus 100, 200. In one example embodiment, an air logic sensor on the rear flange of proofer apparatus 100 signals spring valve 252 to raise pressure cylinder 214 and lift the proofer away from the roller. In another related embodiment, a photo light sensor can be used to detect the end of the substrate thereby actuating valve 252 while button 226 remains depressed.

Proofer apparatus 100 is preferably configured to be self-equalizing thereby providing a wrist action to allow the rolls on the ink proofer tool 1 and roller 106 to compensate for any wobble during the ink proofing process. By using a pneumatic drive mechanism, the concerns that ink technicians have about utilizing solvents with low flash points may be alleviated when using the present invention. In a relating embodiment, the drum of roller 106 includes a speed sensing device that will read out in feet per minute or another convenient unit of measurement, which will provide an actual speed read out with control and various speed controls. Proofer apparatus 100 may also include a down pressure gauge to determine what pressure is being applied with the ink proofer tool 1.

In this example embodiment, the drive motor is preferably of the air type (½ horse power) but proofer apparatus 100 can also be configured to operate with a clutch drive and clutch brake assembly. In other embodiments, the drive motor can include a DC motor, an electric motor or an AC motor.

In this example embodiment, roller 20 is comprised of a natural rubber coating of 70-75 Durometer hardness bonded onto an aluminum roll. Proofer conditions of printing encountered during commercial flexographic printing while providing faster proofing speeds as a result of the air driven motor.

One example embodiment of the ink proofer apparatus can proof a maximum width of six inches. Further, the proofer will process almost any length of substrate desired. A minimum of 9½ inches of substrate is generally required. Additional widths may be specified in increments of 2 inches up to a width of 14 inches.

Ink proofer apparatus 100, 200 may also be adjusted for proofing speeds of 50 to 1,500 feet per minute with other ranges being available as desired. Ink proofer 100, 200 includes precision readouts for speed of the substrate and down pressure on the proofer apparatus 100, 200. In an example embodiment relating to preparing ink samples using non-porous substrates, a proofing speed of about 150 feet per minute is used. In a related embodiment relating to preparing ink samples using porous substrates, a proofing speed of about 50 feet per minute is used.

In one example embodiment, ink proofer apparatus 100 is fully automatic, but manual operations are also contemplated. The substrate is introduced in the left side of the ink proofer apparatus 100 (denoted by arrow A) and by pressing the actuation button, proofer apparatus 100 automatically feeds the substrate through the proofer apparatus 100 and the substrate is discharged on the right side.

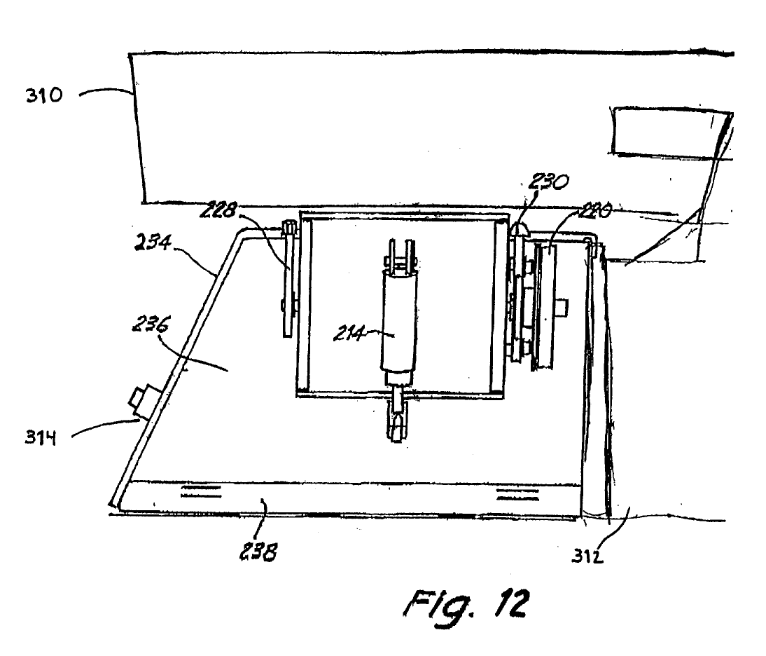

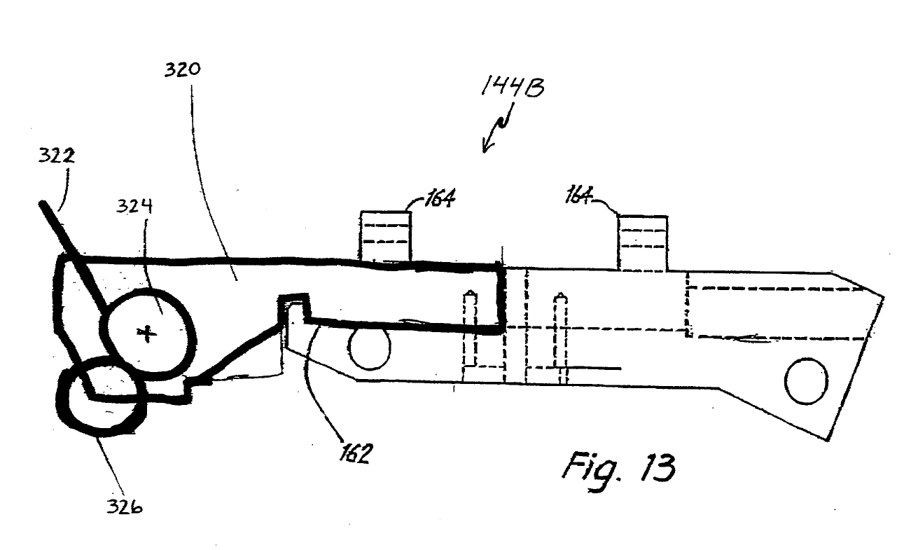

FIGS. 11 and 12 illustrate perspective and side views, respectively, of another embodiment of ink proofer apparatus 300, which includes ultraviolet (UV) lamp 310 and mounting bracket 312. UV lamp 310 is held in place by mounting bracket 312 and is mounted to allow UV lamp 310 to pivot upwardly and away from the substrate (not shown). Such an arrangement allows for cleaning and maintenance of ink proofer apparatus 300. UV lamp 310 is useful for curing ink applied to a substrate which passes below UV lamp 310.

FIG. 12 illustrates switch 314 for operating UV lamp 310 mounted to the housing of ink proofer apparatus 200. In a related embodiment, UV lamp 310 is operated by on/off switch 120.

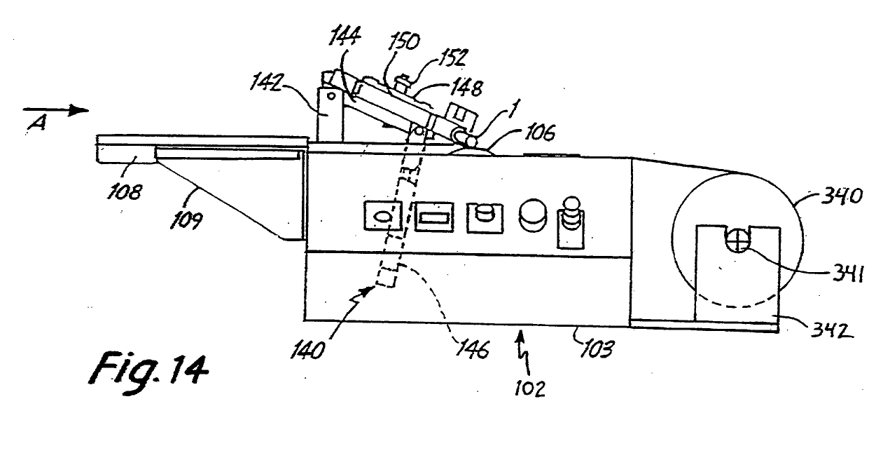

Referring to FIG. 13, there is illustrated another embodiment of ink proofer apparatus 100, 200 of the invention. In particular, ink proofer apparatus includes ink proofer tool cartridge assembly 320 configured to sit within universal proofer holder 144B. Proofer tool cartridge assembly 320 is detachable, allowing for easy removal from universal holder 144B for ease of cleaning and/or changeover to another ink color or type. Proofer tool cartridge assembly 320 includes doctor blade 322, anilox roll 324, and transfer roll 326.

Referring now to FIG. 14, an example embodiment of a take-up roll arrangement 340 may be attached to any of the ink proofer arrangements disclosed herein. In this example embodiment, take-up roll 340 is disposed on rod 341 which is disposed on roll support frame 342 located at the opposite end of the ink proofer from supply roll 240, illustrated in FIG. 9. Take-up roll 340 is configured to take up the inked substrate at the outlet end of the proofer. Hence, after the substrate has passed from the inlet end of the ink proofer, between ink proofer tool 1 and roller 106, such as in FIG. 4, the inked substrate travels off the end of base unit 102 and is wound onto take-up roll 340. In this example embodiment, roll support 342 includes at least one bracket for mounting take-up roll 340 via rod 341.

Referring again to FIG. 9, in yet another example embodiment, a substrate roll support 350 (not shown) is adapted to be mounted above or below base unit 102 at a feeding end of the proofer apparatus before the substrate is proofed. In this example embodiment, roll support 350 holds multiple substrate rolls, preferably in a vertical (and parallel) configuration, allowing a technician a choice of multiple substrates available for ink proof sample generation. In this example embodiment, four rolls are used. In an alternative embodiment, roll support 350 is not attached directly to base unit 102, but is free standing and located proximate to base unit 102 near its feeding end.

Referring to FIGS. 8A and 10A, in a related example embodiment of system 250 pressure cylinder 214 is adapted to include spring 370 disposed within pressure cylinder 214. Spring 370 causes a force to be applied to piston 215, which in turn pulls unibody 210 and ink proofer tool 1 downwards and into a contact position with roller 218. In another related embodiment, spring 370 is adjustable so as to allow a range of pressures.

In a further contemplated embodiment of the invention, the ink proofer apparatus 100 is adapted to accept an anilox roll and doctor blade from a narrow web margin printing press. Such an embodiment would likely be physically larger than other embodiments of the invention, as narrow webs are in the range of twelve to sixteen inches in width. An advantage of this embodiment is the ability to prepare samples with the actual anilox roll and doctor blade that is used on the printing press.

In a further example embodiment, drive rollers 106 and 218 are driven by a drive motor 602, the drive motor being operated by control system 600. Control system 600 may include a computer, a hand-held device, or similar device. Drive motor 602 may be electric, hydraulic, or pneumatic. In an example embodiment, drive motor 602 is of the servo motor type. Servo motors offer an ink proofer technician precise control over the speed and positioning of the drive roll.

Control system 600 has the ability to use stored data to set-up the ink proofer apparatus. For example, an ink proofer technician might wish to prepare an ink sample identical to a sample that was prepared in the past. To do so, the technician can find the data stored in control system 600 that corresponds to the previous ink sample, and set the ink proofer apparatus to operate at those parameters to produce an identical ink sample. Further, control system 600 has the ability to operate not only the ink proofer apparatus, but also one or more printing presses. Such a configuration allows a technician to modify the settings of a printing press based on the ink samples that prepared on the ink proofer apparatus, or modify the settings of the ink proofer apparatus based on those of the printing press, all from the same control system.

Computer controlled valve 604 is adapted to regulate the amount of pressure that is delivered to the ink proofer apparatus. Valve 604 is also operated by control system 600, and allows an ink proofer technician to control the pressure between drive roller 106 and ink proofer tool 1 from control system 600.

Control system 600 can thus adjust the force with which the impression roll is applied to the substrate as the substrate is moved between the impression roll and the drive roll as well as other parameters. This allows control system 600 to adjust to the differing resiliencies of the impression roll and the drive roll as well as other parameters to provide optimal proofing conditions to most effectively simulate the action of the press and minimize press down time.

One ink proofer tool that can be used with the present invention is that described in U.S. patent applications Ser. Nos. 11/382,381 and 11/382,435 the entire contents of which are hereby incorporated herein by reference.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. A kit for use in preparing ink proofs, the kit comprising:
an ink proofing tool comprising an anilox roller shiftable between a first position in contact with an impression roller and a second position not in contact with the impression roller,
an ink proofer apparatus comprising
transport structure to support and operably engage an exchangeable endless movable transport surface operably supported in a housing,
a motor operably connected to the transport structure to drive the endless movable transport surface, and
a holder to support the ink proofing tool in operable relation to the transport structure, the holder being operably shiftable between a first position wherein the impression roller is not in contact with the endless movable transport surface or a substrate supported by the transport surface and a second position wherein the impression roller is in contact with a substrate supported by the endless movable transport surface; and
at least two endless movable transport surfaces which have different preselected surface qualities and which are exchangeably couplable to the transport structure.

2. The kit as claimed in claim 1, wherein the preselected surface qualities include variations in resiliency.

3. The kit as claimed in claim 1, wherein the endless movable transport surface comprises a rotating drum.

4. The kit as claimed in claim 3, wherein the rotating drum comprises a cylindrical metallic drum.

5. The kit as claimed in claim 4, wherein the metallic drum is surface treated.

6. The kit as claimed in claim 5, wherein the surface treatment is selected from a group consisting of polishing, chroming, anodizing, nickel plating and hard coating.

7. The kit as claimed in claim 1, wherein the endless movable transport surface further comprises a resilient elastomeric surface.

8. The kit as claimed in claim 7, wherein the elastomeric surface has a durometer hardness of between about forty and about seventy five.

9. The kit as claimed in claim 1, further comprising a control system adapted to selectively adjust a force with which the impression roll is applied to the substrate when the impression roll is in contact with substrate as a function of the different preselected surface qualities of the at least two endless movable transport surfaces.

10. The kit as claimed in claim 1, wherein the endless movable transport surface comprises a continuous belt.

11. A method of altering proofing conditions in an ink proofer apparatus, the ink proofing apparatus to be used with an ink proofer tool including an anilox roller that can be brought into contact with an impression roller, the ink proofer apparatus comprising transport structure to support and operably engage an exchangeable endless movable transport surface and having a motor operably connected to the transport structure to drive the endless movable transport surface and a holder that supports the ink proofer tool, the holder being operably shiftable between a first position wherein the impression roller is not in contact with the endless movable transport surface or a substrate supported by the endless movable transport surface and a second position wherein the impression roller is in contact with the endless movable transport surface or the substrate supported by the endless movable transport surface; the method comprising:
selecting a first endless movable transport surface having a first surface quality;
mounting the first endless movable transport surface to the transport structure;
preparing a first proof; selecting a second endless movable transport surface having a second surface quality;
mounting the second endless movable transport surface in place of the first endless movable transport surface; and
preparing a second proof.

12. The method as claimed in claim 11, further comprising selecting the first endless movable transport surface and the second endless movable transport surface on a basis of variation in resiliency.

13. The method as claimed in claim 11, further comprising configuring the endless movable transport surface as a rotating drum.

14. The method as claimed in claim 13, further comprising configuring the rotating drum to comprise a cylindrical metallic drum.

15. The method as claimed in claim 14, further comprising configuring the cylindrical metallic drum to include a surface treatment.

16. The method as claimed in claim 15, further comprising selecting the surface treatment from a group consisting of polishing, chroming, anodizing, nickel plating and hard coating.

17. The method as claimed in claim 11, further comprising configuring the endless movable transport surface to comprise an elastomeric material.

18. The method as claimed in claim 17, further comprising configuring the elastomeric material to have a durometer hardness of between about forty and about seventy five.

19. The method as claimed in claim 11, further comprising adjusting the force with which the impression roll is applied to the substrate when the impression roll is in contact with substrate via a control system whereby the ink proofer apparatus is adjusted to vary related to the first and second surface qualities.
